(19) United States
(12) Patent Application Publication
(10) Pub. No.: US 2021/0149953 A1
(43) Pub. Date: May 20, 2021

(54) CREATING A PLAYLIST OF EXCERPTS THAT INCLUDE MENTIONS OF KEYWORDS FROM AUDIO RECORDINGS FOR PLAYBACK BY A MEDIA PLAYER

(71) Applicant: salesforce.com, inc., San Francisco, CA (US)

(72) Inventors: Vandit Garg, Antioch, CA (US); Anthony Desportes, San Francisco, CA (US); Brian Truong, San Francisco, CA (US); James Matt Holland, San Francisco, CA (US); Lovish Agarwal, San Francisco, CA (US); Lisa Kaplan, Piedmont, CA (US); Melanie Krassel, San Francisco, CA (US); Yuan Wang, Dublin, CA (US); Bhupinder Johal, Surrey (CA); Wenying Yang, San Francisco, CA (US)

(73) Assignee: salesforce.com, inc., San Francisco, CA (US)

(21) Appl. No.: 16/833,399

(22) Filed: Mar. 27, 2020

Related U.S. Application Data
(60) Provisional application No. 62/937,786, filed on Nov. 19, 2019.

(51) Int. Cl. G06F 16/638; G06F 16/68; G06F 3/0482

(52) U.S. Cl. CPC G06F 16/639; G06F 3/0482; G06F 16/686

(57) ABSTRACT

Implementations are described for creating a playlist of excerpts from audio recordings. In one implementation, a selection of a first audio recording for playback by a media player, a selection that identifies a first keyword of interest, and a selection of a user interface element in the media player, are accepted from a user. Data that identifies a first excerpt, from the first audio recording, that includes a mention of the first keyword of interest, is added to a playlist. A selection of a second audio recording for playback and another selection of the user interface element are accepted from the user. Data that identifies a second excerpt, from the second audio recording, that includes a mention of a second keyword of interest, is added to the playlist.

### CROSS-REFERENCE TO RELATED APPLICATIONS

This application claims the benefit of U.S. Provisional Application No. 62/937,786, filed Nov. 19, 2019, which is hereby incorporated by reference.

### TECHNICAL FIELD

One or more implementations relate to the field of media players; and more specifically, to creating playlists of excerpts from audio recordings.

### BACKGROUND ART

Some media players allow a user to create a playlist of audio or video recordings. An audio recording is audio data that has been stored on machine-readable media for later playback. Audio of an audio recording may be combined with other media (e.g., an audio recording may comprise the audio portion of a video recording). Playback is the action of causing media recordings to be heard or seen again via an electronic device. For example, playback of an audio recording is the action of causing the audio recording to be heard again (e.g., via an end user device). Playback might be performed by a media player; i.e., software that provides a graphical user interface for playing back media via an electronic device.

### BRIEF DESCRIPTION OF THE DRAWINGS

The following figures use like reference numbers to refer to like elements. Although the following figures depict various example implementations, alternative implementations are within the spirit and scope of the appended claims. In the drawings:

FIG. 1A is a diagram that shows a media player with support for selection of a keyword of interest, according to some implementations.

FIG. 1B is a block diagram that shows communication between a media player, code, and a server in the context of creating a playlist of excerpts that include mentions of a keyword of interest, according to some implementations.

FIG. 1C is a flow diagram that shows a method for creating a playlist of excerpts that include mentions of keywords from audio recordings, according to some implementations.

FIG. 2A is a diagram that shows a data structure for a playlist that includes data identifying excerpts, according to some implementations.

FIG. 2B is a diagram that shows a data structure for data to locate an excerpt in an audio recording, according to some implementations.

FIG. 2C is a flow diagram that shows a method for adding, to a playlist, data that identifies an excerpt, according to some implementations.

FIG. 3A is a diagram that shows a data structure for a playlist that includes an excerpt corresponding to one or all mentions of a keyword of interest in an audio recording, according to some example implementations.

FIG. 3B is a diagram that shows a data structure for a playlist that includes multiple excerpts corresponding to multiple mentions of a keyword of interest in an audio recording, according to some example implementations.

FIG. 3C is a diagram that shows a data structure for a playlist that includes multiple excerpts corresponding to multiple mentions of a keyword of interest in multiple audio recordings, according to some example implementations.

FIG. 3D is a diagram that shows a data structure for a playlist that includes multiple excerpts corresponding to multiple mentions of multiple keywords of interest in an audio recording, according to some example implementations.

FIG. 4 is a flow diagram that shows a method for retrieving audio for excerpts in a playlist of excerpts, according to some example implementations.

FIG. 5A is a diagram that shows a graphical user interface that allows a user to search for audio recordings that include mentions of a keyword, according to some implementations.

FIG. 5B is a flow diagram that shows a method for creating a playlist of excerpts from audio recordings based on one or more results of a search for audio recordings that include mentions of a keyword, according to some implementations.

FIG. 6A is a block diagram illustrating an electronic device, according to some implementations.

FIG. 6B is a block diagram of a deployment environment, according to some implementations.

### DETAILED DESCRIPTION

The following description describes implementations for creating a playlist of excerpts, that include mentions of keywords, from audio recordings for playback by a media player. A playlist is data that identifies one or more audio recordings, or portions thereof, for playback. Typically, a playlist includes data that identifies more than one audio recording and a media player will play the audio recordings (or excerpts thereof) in the playlist sequentially.

A keyword is a word of particular significance in a particular context. For example, a keyword corresponding to the name of a business competitor might be of particular significance in the context of a salesperson pitching a prospect. For another example, a keyword corresponding to the name of a product or service might be of particular significance in the context of a customer service representative providing telephone support to a customer. Although reference is made herein to “a keyword,” “keywords,” “keyword of interest” and the like, implementations described herein may support key phrases (i.e., a phrase of particular significance in a particular context).

Creating a Playlist of Excerpts

Media Player

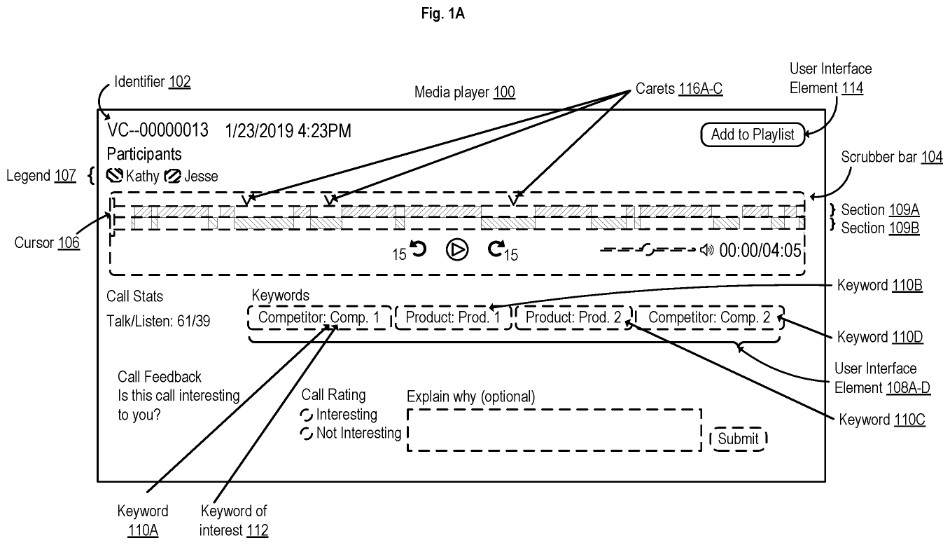

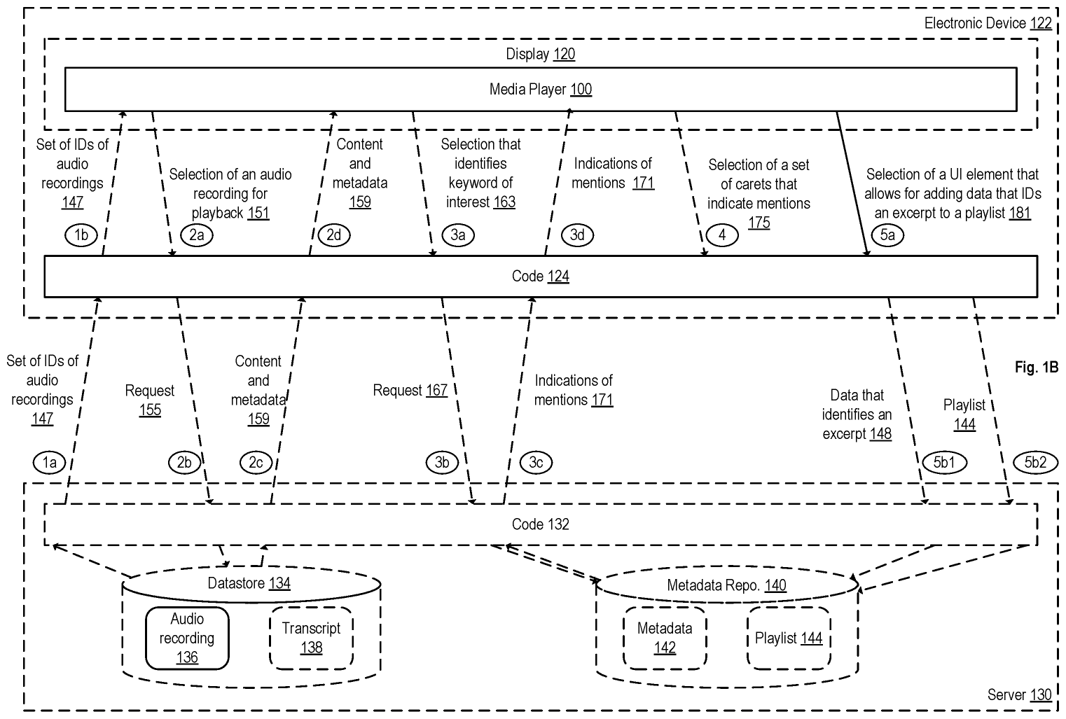

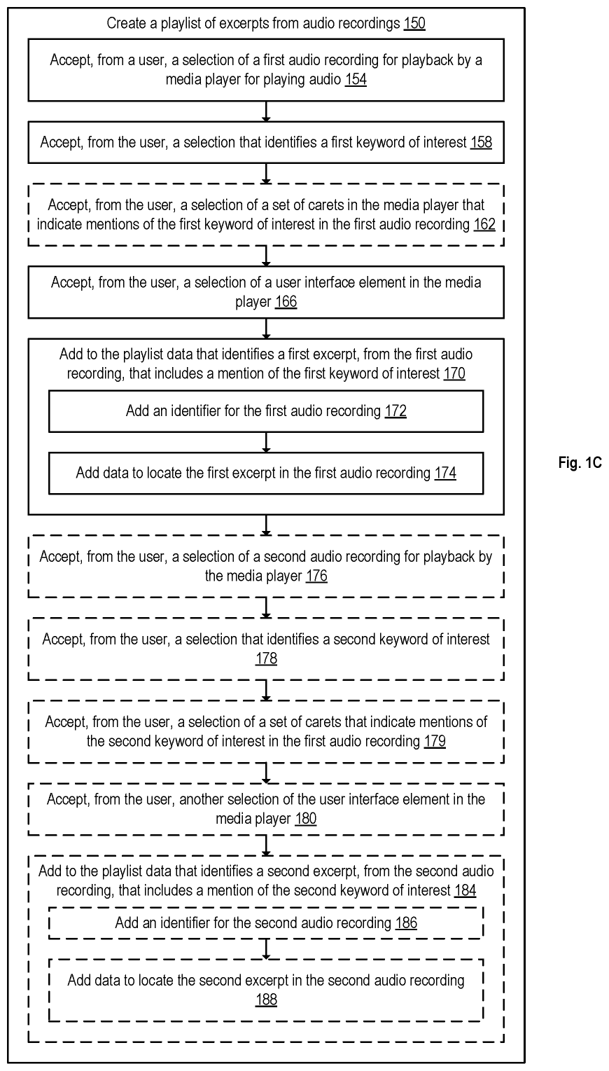

FIG. 1A is a diagram that shows a media player with support for selection of a keyword of interest, according to some implementations. As used herein, the term “media player” may refer to software that provides a graphical user interface for playing back media via an electronic device, and/or to the graphical user interface provided by such software. Media player 100 is shown with the selection of an example audio recording for playback. Namely, media player 100 is shown with the selection of an audio recording with an identifier 102 (ID) for the audio recording with the value of “VC-00000013.” An identifier 102 for an audio recording is data that identifies the audio recording; e.g., a filename, a title, etc. In some implementations, media player 100 shows other information relating to the audio recording, such as a timestamp (e.g., “1/23/2019 4:23 PM” as shown), legend 107 that shows identifiers for participants in the audio recording (e.g., “Kathy” and “Jesse”), statistics (e.g., “Talk/Listen: 61/39,” corresponding to a talk/listen ratio for one of the participants), etc. In some implementations, the timestamp corresponds to a time that the audio recording was stored, the time that the recorded audio started, or the time that the recorded audio stopped. The audio recording might be of a conversation (i.e., an interchange between two or more persons and/or machines), a monologue (i.e., one person's speech) such as in a presentation or oration, a song, etc. For example, one or more audio recordings might each be of a conversation between an agent of a call center and a caller. An agent at a call center is a person who handles incoming or outgoing calls for a business at a call center, and a caller is a person or machine who makes a call.

Media player 100 also shows a scrubber bar 104 that shows a timeline for the audio going from a beginning of the audio recording on the left to an ending of the audio recording on the right. The current play position in the audio recording is shown by cursor 106. In scrubber bar 104, the time that each of the participants was talking is shown using the indicators shown in the legend 107 for the respective participants. In particular, the scrubber bar 104 is divided it includes a section 109 for each participant (as shown, section 109A for the participant identified as “Jesse”; section 109B for the participant identified as “Kathy”). Section 109 runs the length of scrubber bar 104. Also, section 109 includes, for each participant: 1) portions with an indicator from the legend 107 (e.g., shading) to indicate the times when that participant was talking (or providing some other kind of meaningful audio input); and 2) portions without an indicator (e.g., blanks) during the times when that participant was not talking (or not providing some other kind of meaningful audio input). In other words, section 109 in scrubber bar 104 shows who is talking at what points in the audio recording. For a given audio recording, scrubber bar 104 might include one, two, or more sections 109 if the audio recording includes one, two, or more participants respectively.

Implementations might include other user interface (UI) elements in scrubber bar 104. A UI element is an element of which a user interface is comprised, such as an input element (e.g., dropdown list, toggle), navigation element (e.g., search field, icon), informational element (e.g., text label, visualization), container element (e.g., accordion), etc. An implementation might include one or more of UI elements that allow a user to: 1) start, pause, and/or stop playback of an audio recording (e.g., as indicated by the play icon immediately below the center of section 109B); 2) fast forward or rewind playback (e.g., as indicated by the two icons respectively to the left and right of the play icon); 3) view a time corresponding to the current play position in the audio recording and the duration of the audio recording (e.g., the values “00:00/04:05” shown immediately below the bottom right-hand corner of section 109B); 4) adjust the volume of the playback (e.g., as indicated by the slider and the speaker icon to its right); etc.

Media player 100 includes one or more UI elements 108 for one or more keywords 110. A UI element 108 allows a user to select a keyword of interest 112 (i.e., make a selection that identifies a keyword of interest 112) and indicate mentions (i.e., instances) of that keyword of interest 112 in the audio recording via a caret 116 in scrubber bar 104 (a caret is a UI element that indicates a position in the audio recording). Some implementations associate a keyword 110 with a type (e.g., a classification of that keyword). In the example shown in FIG. 1A, media player 100 includes UI elements 108A-D that respectively include keyword 110A (with a value of “Comp. 1,” associated with a type “Competitor”), keyword 110B (with a value of “Prod. 1,” associated with a type “Product”), keyword 110C (with a value of “Prod. 2,” associated with a type “Product”), and keyword 110D (with a value of “Comp. 2,” associated with a type “Competitor”). Keyword 110A has been selected as keyword of interest 112, and carets 116A-C indicate mentions of keyword 110A (i.e., “Comp. 1”) in the audio recording.

Other implementations show UI element 108 and/or carets 116 differently. For example, an implementation might display one UI element 108 with a set of keywords 110 (e.g., via a drop-down list) for a user to select. Another implementation might allow a user to select more than one keyword 110 as a keyword of interest 112 and display a caret 116 for each mention of each keyword of interest 112 (e.g., carets 116 for one keyword of interest 112 in one color, carets 116 for another keyword of interest 112 in another color, etc.). When an audio recording has more than one participant, an implementation might show a caret 116 associated with the section 109 corresponding to the participant that mentioned the keyword of interest 112 to which the caret 116 corresponds. For example, in an audio recording with two participants (as FIG. 1A shows), carets 116A-C might correspond to mentions of keyword 110A (“Comp. 1”) by the participant identified as “Jesse” because carets 116A-C are located above section 109A (which corresponds that participant), rather than below section 109B (which corresponds to the participant identified as “Kathy”). Implementations might show different types of information in UI element 108. For example, an implementation might not include a type of keyword (e.g., “Competitor” or “Product”) in UI element 108. Additionally, or alternatively, an implementation might include a number of mentions of a keyword 110 in a corresponding UI element 108 (e.g., for UI element 108A, an implementation might include “(3)” to indicate that the audio recording includes three mentions of the keyword “Comp. 1”).

Implementations of media player 100 allow for navigation to positions in the audio recording where mentions of a keyword of interest 112 occur. For example, an implementation might position cursor 106 in scrubber bar 104 at or before a caret 116 corresponding to a first mention in the audio recording of a keyword 110 when the user selects the UI element 108 corresponding to the keyword 110. In the example shown in FIG. 1A, cursor 106 might be positioned at caret 116A when a user selects UI element 108A (and thus keyword 110A as keyword of interest 112). Subsequent user selections of the UI element 108, or another UI element (e.g., a button for advancing cursor 106 to the next mention of the keyword 110), might advance cursor 106 to the position of the next mention (if any) of the corresponding keyword 110. Additionally, or alternatively, an implementation of media player 100 might allow a mode of playback such that, when a keyword of interest 112 is selected, only excerpts that include mentions of the keyword of interest 112 are played when a user selected the UI element to start playback.

Media player 100 further includes a UI element 114 (shown with text “Add to Playlist”) that a user may select to add, to a playlist, data that identifies an excerpt. An excerpt is a portion of an audio recording that is less than all of the audio recording. For example, an excerpt of an audio recording is a portion of the audio recording with a duration less than that of the audio recording. Different implementations of media player 100 may support different modes of operation for UI element 114 and/or adding data that identifies an excerpt to a playlist, and some implementations may allow a user to select a mode of operation.

One mode of operation includes, responsive to a user selecting UI element 114, adding data that identifies an excerpt to a playlist for all mentions of a keyword of interest 112 in an audio recording. Another mode of operation includes, responsive to a user selecting UI element 114, adding data that identifies an excerpt to a playlist for only some mentions of a keyword of interest 112. For example, implementations might add data that identifies an excerpt for only a first mention, or a given number of mentions, of the keyword of interest 112. An implementation might support a user specifying the number of mentions to be added to a playlist in a configuration setting for media player 100, and/or in UI element 114 (or another UI element). Yet another mode of operation might blend the modes of operation previously described. For example, an implementation might support a user selecting one or more mentions of a keyword of interest 112 in media player 100 (e.g., by selecting one or more carets 116, which may be selectable in some implementations). A blended mode of operation might 1) add data that identifies an excerpt to a playlist for all mentions of a keyword of interest 112 if a user has not selected particular mentions of a keyword of interest 112, and 2) add data that identifies an excerpt to a playlist for only mentions of a keyword of interest 112 that the user has selected, if a user has selected particular mentions.

Communication with Media Server

FIG. 1B is a block diagram that shows communication between a media player 100, code, and a server 130 in the context of creating a playlist of excerpts that include mentions of a keyword of interest 112, according to some implementations. FIG. 1B shows an implementation where electronic device 122 includes code 124 that includes instructions for media player 100 and a display 120 which displays media player 100. FIG. 1B also shows server 130 that includes datastore 134, metadata repository 140, and code 132. Code 132 includes instructions for interfacing with datastore 134 and metadata repository 140. Datastore 134 includes audio recording 136 and transcript 138 for the audio recording 136. A transcript is an electronic record of words in an audio recording (e.g., a text file). Metadata repository 140 includes metadata 142 and, in some implementations, a playlist 144. Metadata is data that describes other data. For example, in one implementation, metadata 142 describes audio recording 136. The implementation shown in FIG. 1B is illustrative and not limiting. Implementations may store metadata 142 and/or audio recording 136 in different ways (e.g., in separate files, in one database, in several databases, etc.). Moreover, some metadata for audio recording 136 (e.g., an identifier 102 for the audio recording 136) might be stored in or with audio recording 136 and other metadata for audio recording 136 (e.g., indications of mentions 171) might be stored separately.

At time 1a (indicated with circled reference “1a”), a set of IDs for audio recordings 147 is transmitted by server 130 (i.e., by code 132) to electronic device 122. The set of IDs for audio recordings 147 is based on audio recordings 136 in datastore 134. In one implementation, the set of IDs for audio recordings 147 is transmitted by server 130 to electronic device 122 responsive to a user of electronic device 122 selecting a UI element in media player 100 to browse audio recordings 136, and code 124 transmitting a request to server 130 for a set of IDs for audio recordings 147. In another implementation, the set of IDs for audio recordings 147 is transmitted by server 130 to electronic device 122 responsive to a user performing a search with media player 100 for audio recordings 136 that include mentions of a keyword of interest 112, and code 124 transmitting a request to server 130 for a set of IDs for audio recordings 147 that include mentions of the keyword of interest 112 (which might also include code 132 submitting a query to, and receiving query results from, metadata repository 140).

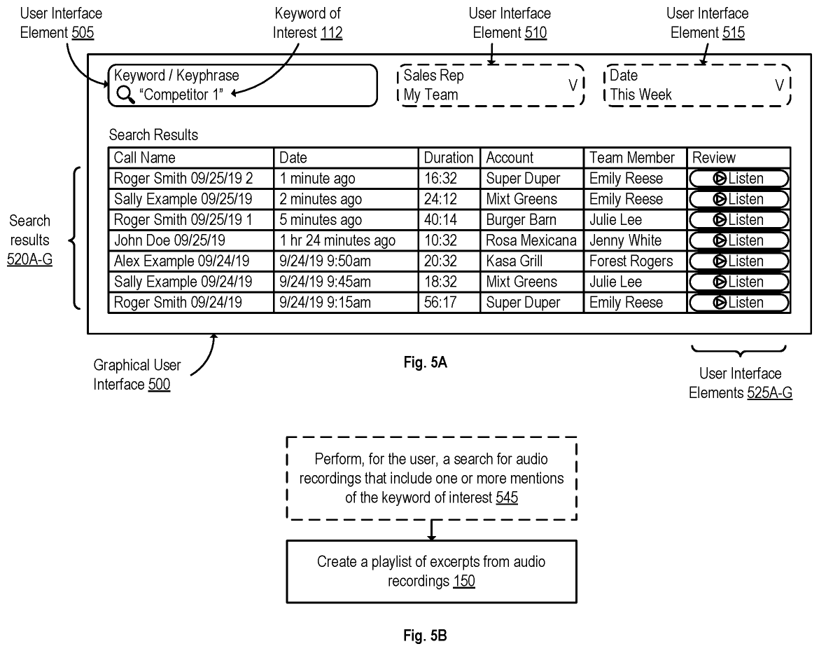

At time 1b (indicated with circled reference “1b”), the set of IDs for audio recordings 147 is displayed in media player 100 such that a user may select a corresponding audio recording 136 for playback by media player 100. In one implementation, the set of IDs for audio recordings 147 are displayed in a browse file dialog box. In another implementation described later herein referring to FIG. 5A, the set of IDs for audio recordings 147 are included in search results (e.g., search results 520 shown in FIG. 5A) responsive to a user performing a search with media player 100 for audio recordings 136 that include mentions of a keyword of interest 112.

At time 2a (indicated with circled reference “2a”), code 124 receives a selection of an audio recording for playback 151. In one implementation, responsive to receiving the selection of an audio recording for playback 151, code 124 performs block 154 shown in FIG. 1C. In block 154, a selection of a first audio recording 136 for playback by media player 100 is accepted from the user. For example, a user may select an identifier 102 for an audio recording 136 from the set of IDs for audio recordings 147, and the user's selection is accepted in block 154. In another implementation, a user may select a set of audio recordings 136 for playback by media player 100 (e.g., to be played back sequentially). From block 154, flow passes to block 158.

At time 2b (indicated with circled reference “2b”), code 124 transmits a request 155 for content and metadata for audio recording 136 to server 130. In one implementation, responsive to receiving the request, code 124 retrieves content for audio recording 136 from datastore 134, and metadata 142 for audio recording 136 from metadata repository 140.

At time 2c (indicated with circled reference “2c”), code 132 transmits content and metadata 159 for audio recording 136 to electronic device 122. Different implementations may handle the transmission of content and metadata 159 between server 130 and electronic device 122 in different ways. For example, implementations may support server 130 transmitting content and metadata 159 to electronic device 122 via different streaming and/or buffering techniques. Thus, implementations may involve server 130 transmitting content and metadata 159 to electronic device 122 in different parts at different times (e.g., via adaptive or multi bitrate streaming). Other implementations may support server 130 transmitting content and metadata 159 to electronic device 122 without streaming and/or buffering techniques (e.g., as a single file at one time). Implementations may transmit the metadata 142 of content and metadata 159 separately to electronic device 122 (e.g., to allow media player 100 to display some or all of the metadata while content is buffered for later playback).

At time 2d (indicated with a circled reference “2d”), responsive to receiving content and metadata 159, code 124 1) displays metadata for audio recording 136 in media player 100 (e.g., UI elements 108 for keywords 110; identifiers for participants in legend 107, sections 109 for each participant; etc.); and/or 2) begins playback of the audio recording 136 with the content, or buffers the content for future playback. Content might be buffered for future playback: 1) if playback is yet to occur, when a user of media player 100 selects a UI element that starts playback; and/or 2) if playback is occurring, when a current play position (e.g., as indicated by cursor 106) reaches the portion of the audio recording 136 that includes the content; etc. At time 3a (indicated with circled reference “3a”), code 124 receives a selection 163 that identifies a keyword of interest. In one implementation, responsive to receiving the selection 163, code 124 performs block 158 shown in FIG. 1C. In block 158, a selection 163 that identifies a first keyword of interest 112 is accepted from the user. In some implementations, a selection 163 that identifies a set of one or more keywords of interest 112, and/or a set of one or more selections 163 that identify a set of one or more keywords of interest 112, is accepted from the user. For example, an implementation might support a user selecting, in one or more selections 163, one or more UI elements 108, each of which corresponding to a respective one of keywords 110. From block 158, flow passes to block 162.

In one implementation at time 3b (indicated with circled reference “3b”), code 124 transmits a request 167 for indications of mentions 171 for audio recording 136 to server 130. In one implementation, an indication of a mention 171 includes data that indicates a position of a mention in audio; e.g., an offset relative to a beginning of an audio recording 136. In another implementation, an indication of a mention 171 includes data that identifies a participant who made the mention (i.e., said the keyword). Additionally, or alternatively, an indication of a mention 171 may include an identifier for the keyword 110 to which the mention corresponds.

In one implementation, responsive to receiving the request 167, code 124 retrieves indications of mentions 171 for audio recording 136 from metadata repository 140 (indications of mentions 171 may be stored in metadata 142 for audio recording 136). In another implementation, content and metadata 159 includes indications of mentions 171 for audio recording 136, and code 124 need not transmit request 167 for indications of mentions 171.

At time 3c (indicated with circled reference “3c”), code 132 transmits indications of mentions 171 for audio recording 136 to electronic device 122. Indications of mentions 171 might include indications of mentions corresponding only to the keyword of interest 112 that the user selected (i.e., in selection 163). Alternatively, indications of mentions 171 might include indications of mentions corresponding to keyword of interest 112 and other keywords 110 (e.g., keywords 110 for which indications of mentions are included in metadata 142).

At time 3d (indicated with circled reference “3d”), code 124 displays the indications of mentions 171 for the one or more keywords of interest 112 in media player 100. In one implementation, carets 116 are displayed in scrubber bar 104 of the media player 100 for one or more of the indications of mentions 171.

At time 4 (indicated with circled reference “4”), in one implementation, code 124 receives a selection of a caret 116 that indicates a mention 175. Responsive to receiving the selection of a caret 116 that indicates a mention 175, code 124 performs block 162 shown in FIG. 1C. Block 162 includes accepting, from a user, the selection of a set of carets 116 in the media player 100 that indicate mentions of the first keyword of interest 112 in the first audio recording 136. In another implementation at time 4, code 124 receives a selection of a mention of a keyword of interest 112 other than by selection of a caret 116. For example, an implementation may support a user selecting an area of section 109 to select one or more mentions of a keyword of interest 112 in the corresponding portion of the audio recording 136, and code 124 receives a selection of those mentions of the keyword of interest 112. Implementations that support block 162 and ways of selecting one or more mentions of a keyword of interest 112 allow a user to create a playlist 144 which is more relevant. A playlist 144 which is more relevant in turn reduces the computing resources needed when using the playlist 144 (e.g., playing it back, creating a transcript 138 for it, etc.). From block 162, flow passes to block 166.

At time 5a (indicated with circled reference “5a”), code 124 receives a selection 181 of a UI element 114 that allows for adding data that identifies an excerpt to a playlist 144. It should be noted that a user may select UI element 114 before or after playback of an audio recording 136 has begun. In one implementation, responsive to receiving the selection 181, code 124 performs block 166 shown in FIG. 1C. Block 166 includes accepting, from the user, a selection 181 of a UI element 114 in the media player 100. From block 166, flow passes to block 170.

Block 170 includes adding, to a playlist 144, data that identifies an excerpt 148, from the first audio recording 136, that includes a mention of the first keyword of interest 112. Data that identifies an excerpt 148 is described in more detail later herein referring to other figures. In one implementation, data that identifies an excerpt 148 includes an identifier 102 for an audio recording 136. Block 170 includes block 172 and block 174 in one implementation. In block 172, an identifier 102 for a first audio recording 136 is added to the playlist 144. In block 174, data to locate the first excerpt in the first audio recording 136 is added to the playlist 144. Data to locate the first excerpt in the first audio recording is also described in more detail later herein referring to other figures. In implementations that support a user making a selection 163 that identifies a set of one or more keywords of interest 112, adding data that identifies a first excerpt 148 to playlist 144 may include adding data that includes a mention of at least a first keyword of interest 112 from the set of keywords of interest, which may in turn include one or both of block 172 and block 174. From block 170, flow passes to block 176.

In block 176, a selection 151 of a second audio recording 136 for playback by the media player 100 is accepted from a user. Block 176 may be performed for a second audio recording 136 as block 154 is performed for a first audio recording 136. From block 176, flow passes to block 178.

In block 178, a selection 163 that identifies a second keyword of interest 112 is accepted from the user. The second keyword of interest 112 may be the same as, or different from, the first keyword of interest 112 (e.g., the first and second keywords of interest 112 might have a value of “Comp. 1” (i.e., the same); or the first keyword of interest 112 might have a value of “Comp. 1” and the second keyword of interest 112 might have a value of “Product 1” (i.e., different)). From block 178, flow passes to block 179.

In block 179, a selection of a set of carets 116 that indicate mentions of the second keyword of interest 112 in the first audio recording 136 are accepted from the user. From block 179, flow passes to block 180.

In block 180, another selection 181 of the user interface element 114 in the media player 100 is accepted from the user. Block 180 may be performed for the other selection 181 as block 166 is performed for a selection 181 of the user interface element 114.

Some implementations may support performing other operations before block 180. For example, implementations may support accepting, from a user, a selection 163 that identifies a second keyword of interest 112; and/or accepting, from the user, a selection of a set of carets 116 in the media player 100 that indicate mentions of the first or second keyword of interest 112 in the second audio recording 136. From block 180, flow passes to block 184.

Block 184 includes adding to the playlist 144 data that identifies a second excerpt, from the second audio recording 136, that includes a mention of a second keyword of interest 112. Block 184 optionally includes one or both of block 186 and block 188. In block 186, an identifier 102 for the second audio recording 136 is added. In block 188, data to locate the second excerpt in the second audio recording 136 is added. In implementations that support a user making a selection 163 that identifies a set of one or more keywords of interest 112, adding data that identifies a second excerpt to playlist 144 may include adding data that includes a mention of at least a second keyword of interest 112 from the set of keywords of interest 112, which may in turn include one or both of block 186 and block 188.

Deployment

In one implementation, a playlist 144 of excerpts from audio recordings 136 is created in block 150, as shown in FIG. 1C. In one implementation, block 150 includes block 154, block 158, block 166, block 170, and optionally block 162. In another implementation, block 150 includes those blocks, block 176, block 178, block 180, block 184, and optionally block 179. In one implementation, block 150 is performed by code 124 on electronic device 122. In one such implementation, at time 5b2 (indicated by circled reference “5b2”), code 124 transmits playlist 144 to server 130, and code 132 causes playlist 144 to be stored (e.g., in metadata repository 140).

In another implementation, block 170 and/or block 184 are performed by code 132 on server 130. In one such implementation, at time 5b1 (indicated by circled reference “5b1”), 1) code 124 transmits data that identifies a first excerpt 148 to server 130, responsive to which block 170 is performed on server 130 in respect of a first audio recording 136; and/or 2) code 124 transmits data that identifies a second excerpt 148 to server 130, responsive to which block 184 is performed on server 130 in respect of a second audio recording 136. Code 132 optionally causes playlist 144 to be stored (e.g., in metadata repository 140).

Implementations are described in relation to creating a playlist 144. However, creating a playlist 144 may include creating a playlist 144 from an existing playlist 144. For example, an implementation may use one or more of 1) blocks 154, block 158, block 162, block 166, block 170; or 2) the foregoing blocks and block 176, block 178, block 179, block 180, and block 184, in each case to add data that identifies an excerpt 148 to a playlist 144 that already exists (e.g., by appending the data that identifies an excerpt 148 to the existing playlist 144).

Relatedly, it should be noted that implementations support a user selecting different audio recordings 136 at different times, and the user selecting the same or different keywords of interest 112 from one or more of those different audio recordings 136 during playback thereof. For example, one implementation supports 1) accepting, from the user, a set of one or more selections 163 that identify a set of one or more keywords of interest 112; 2) accepting, from a user at different times, selections of different ones of a plurality of audio recordings 136 for playback by a media player 100 for playing audio; 3) accepting, from the user, selections of a user interface element 114 in the media player 100 during the different times each of the plurality of audio recordings 136 is selected for playback; and 4) adding to a playlist 144, responsive to the selections of the user interface element 114, data that identifies excerpts 148 from the plurality of audio recordings 136, the data including identifiers 102 for each of the plurality of audio recordings 136 and a set of data to locate the excerpts in the plurality of audio recordings 136, wherein each of the excerpts includes a mention of at least one of the set of keywords of interest 112.

It should also be noted that different implementations may support different sequences of the circled references shown in FIG. 1B. For example, one implementation may support code 124 receiving a selection of an audio recording for playback 151 (indicated in FIG. 1B as occurring at time 2a) before receiving a selection 163 that identifies keyword of interest 112 (indicated in FIG. 1B as occurring at time 3a). Another implementation may support code 124 receiving a selection of an audio recording for playback 151 after receiving a selection that identifies keyword of interest 163. It should also be noted that implementations may support some or all of the selections listed. For example, one implementation might not support code 124 receiving a selection of a set of carets 116 that indicate mentions 175 (e.g., the implementation might support a different way of selecting mentions, or create a playlist for all mentions of a keyword of interest 112). Another implementation might not support receiving a selection 163 that identifies keyword of interest 112 (e.g., the implementation might support creating a playlist 144 for all keywords 110). FIG. 1B is illustrative and not limiting.

A playlist 144 of excerpts from audio recordings 136 provides several advantages. A playlist 144 of excerpts allows for different uses of those excerpts. Notably, a media player 100 may play back only excerpts of one or more audio recordings 136 rather than the audio recordings 136. A user that creates a playlist 144 of excerpts may be more interested in playing back the excerpts of audio recordings 136 than the audio recordings 136. In turn, server 130 needs not transmit content to electronic device 122 for the entire duration of audio recordings 136. Creating and playing back a playlist 144 of excerpts thus reduces the consumption of computing resources (e.g., of electronic device 122 and server 130), such as processing cycles and network traffic. A user can also playback only the excerpts of one or more audio recordings 136 in which the user is interested, and/or share the playlist 144 of those excerpts with others. Other uses of a playlist 144 of excerpts provide further advantages as discussed later herein.

Moreover, creating a playlist 144 as described herein provides several advantages. Creating a playlist 144 of excerpts as described is more efficient than other ways of creating a playlist. For example, implementations allow a user to make a selection that identifies a keyword of interest 112 and add to a playlist 144 data that identifies an excerpt that includes a mention of the keyword of interest 112. This is more efficient than the user selecting a start and end position in a scrubber bar 106 of a media player 100 to select the mention of the keyword of interest 112, not only in time but in computing resources and network traffic (e.g., because the user need not search manually to find the start and end position in the media player 100, and thus the media player 100 need not cue and recue audio for playback, etc.).

Also, a user can create a playlist 144 using a media player 100 for playing audio, which facilitates the selection of excerpts to be included in the playlist 144. Media player 100 also lends itself to creating a playlist 144 of excerpts that include mentions of keywords 110. Implementations of media player 100 allow a user to select one or more keywords of interest 112, responsive to which mentions are indicated in a scrubber bar 104 via carets 116. The user can add corresponding excerpts to a playlist 144 by selecting a UI element 114 in media player 100. Implementations may support adding one, some, or all excerpts that include mentions of the one or more keywords of interest 112, as described later herein. Thus, media player 100 provides an intuitive and useful user interface for creating a playlist 144.

Playlist Data Structures

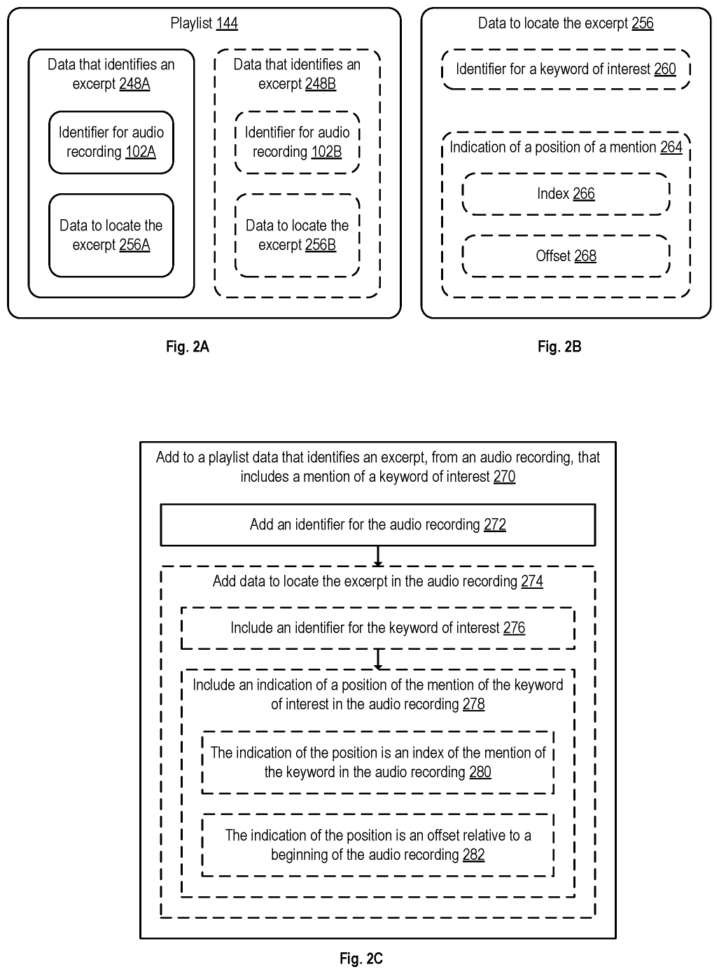

FIG. 2A is a diagram that shows a data structure for a playlist 144 that includes data that identifies an excerpt 248, according to some implementations. Specifically, playlist 144 includes data that identifies an excerpt 248A. Data that identifies an excerpt 248 includes 1) an identifier 102A for an audio recording 136 (e.g., an identifier 102 shown in FIG. 1A), and 2) data to locate the excerpt 256A in the audio recording. A playlist 144 may include data that identifies one or more other excerpts 248. For example, a playlist 144 may include data that identifies an excerpt 248B, which includes 1) an identifier 102B for an audio recording 136 (which may identify the same or a different audio recording 136 that identifier 102A identifies), and 2) data to locate the excerpt 256B in the audio recording 136.

As FIG. 2B shows, data to locate the excerpt 256 in an audio recording 136 may be different in different implementations. Data to locate the excerpt 256 in an audio recording 136 may include 1) an identifier 260 for a keyword of interest (i.e., data that identifies a keyword, such as the keyword itself, an index corresponding to a position of the keyword in a list of keywords, an encoded value of the keyword, etc.); and/or 2) an indication of a position of a mention 264 of the keyword of interest 112 in the audio recording 136. An indication of a position of a mention 264 of the keyword of interest 112 in the audio recording 136 may in turn include one or both of 1) an index 266 of the mention of the keyword 110 in the audio recording 136; and 2) an offset 268 (e.g., relative to a beginning of the audio recording 136). In one implementation, an index 266 of a mention of a keyword 110 in an audio recording 136 is measured from a beginning of the audio recording 136. An index 266 might be relative to a sequence of mentions of a keyword 110 in an audio recording (e.g., as measured from a beginning of the audio recording 136), relative to a sequence of mentions of the keyword 110 by a given participant, etc. Including an index 266 in an indication of a position of a mention 264 allows a media player 100 to provide additional functionality based on the index 266. For example, for a playlist 144 that includes mentions of multiple keywords of interest 112, a media player 100 can highlight and/or filter a keyword of interest 112 (and its mentions) relative to other keywords of interest 112 (and their mentions). For another example, playlists 144 that include information relating to a keyword of interest 112 (e.g., an identifier 260) can be searched by keyword of interest 112. Information relating to a keyword of interest 112 (e.g., an identifier 260) allows for identifying the keyword of interest 112, and thus can be used for logging purposes, accepting feedback on the excerpt and/or audio recording 136, etc.

FIG. 2C is a flow diagram that shows different methods for adding data that identifies an excerpt 248 to a playlist 144, according to some implementations. FIG. 2C shows block 270, block 272, and block 274.

Block 270 includes adding, to a playlist 144, data that identifies an excerpt 248, from an audio recording 136, that includes a mention of a keyword of interest 112. Block 270 includes block 272. In block 272, an identifier 102 for a first audio recording 136 is added to the playlist 144. In one implementation, block 270 includes block 274. From block 272, flow passes to block 274.

Block 274 includes block 276 and/or block 278. In block 276, an identifier 260 for the keyword of interest is included in the data to locate the excerpt 256 in the audio recording 136. From block 276, flow passes to block 278.

In block 278, an indication of a position of the mention 264 of the keyword of interest 112 in the audio recording 136 is included in the data to locate the excerpt 256. In one implementation, the indication of the position of the mention 264 is an index 266 of the mention of the keyword of interest 112 in the audio recording 136 (per block 280). In another implementation, the indication of the position of the mention 264 is an offset 268; e.g., an offset relative to a beginning of the audio recording 136 (per block 282).

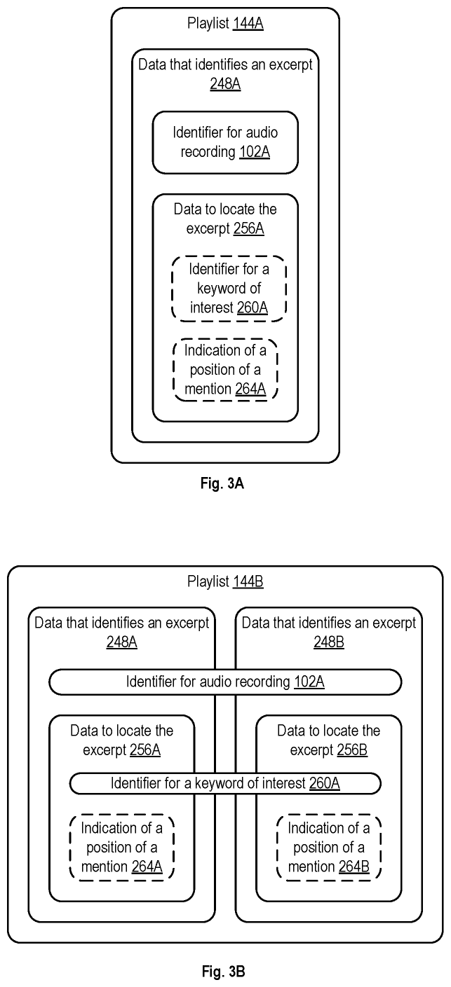

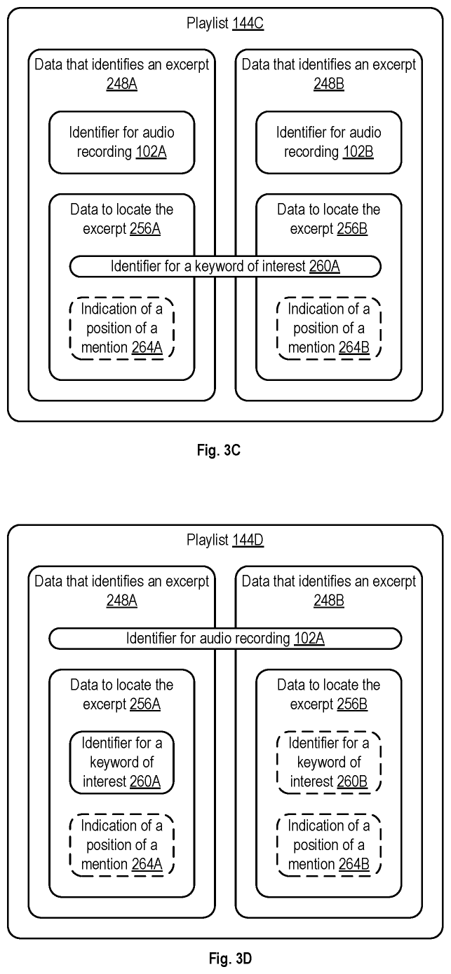

Different combinations of the elements of data shown in FIG. 2A and FIG. 2B provide for different ways of capturing data for playlists 144, and thus different ways that a user can create playlists 144. FIGS. 3A-3D show examples of different combinations.

One Keyword

One Audio Recording: All Mentions

One way of capturing data is shown in FIG. 3A. FIG. 3A is a diagram that shows a data structure for a playlist 144 that includes one or all mentions of a keyword of interest 112 in an audio recording 136, according to some example implementations. Specifically, FIG. 3A shows a playlist 144A. Playlist 144A includes data that identifies an excerpt 248A, which has been described previously. Data that identifies an excerpt 248A includes data to locate the excerpt 256A, which optionally includes one or both of identifier 260A for a keyword of interest, and indication of a position of a mention 264A.

A playlist 144A that includes one or all mentions of a keyword of interest 112 in an audio recording 136 may be created in different situations. In one implementation of media player 100, a user may make selections: 1) of an audio recording 136 for playback by a media player 100; 2) identifying a keyword of interest 112; and 3) of a UI element 114. Referring back to FIG. 1C, these selections may be accepted from the user in block 154, block 158, and block 166 respectively. Block 170 may then be performed. In the example shown in FIG. 1A, keyword of interest 112 has the value “Comp. 1.” Thus, in one implementation, in block 172, an identifier 102 for the first audio recording 136 with a value of “VC-00000013” is added to a playlist 144A as identifier 102A, and in block 174, an identifier 260A for a keyword of interest with a value of “Comp. 1” is added to the playlist 144A.

In another situation, a user may make selections: 1) of an audio recording 136 for playback by a media player 100; 2) identifying a keyword of interest 112; 3) of a caret 116 in the media player 100 from carets 116 that indicate mentions of the keyword of interest 112 in the audio recording 136; and 4) of a UI element 114. Referring back to FIG. 1C, these selections may be accepted from the user in block 154, block 158, block 162, and block 166 respectively. Block 170 may then be performed. Thus, in one implementation, in block 172, an identifier 102 for the first audio recording 136 with a value of “VC-00000013” is added to a playlist 144A as identifier 102A. In block 174, an index 266 of the mention of the keyword 110 in the audio recording 136 is added to the playlist 144A (e.g., an index of selected caret 116 in the set of carets 116).

One Audio Recording: Less Than All Mentions

Another way of capturing data is shown in FIG. 3B. FIG. 3B is a diagram that shows a data structure for a playlist 144 that includes multiple excerpts corresponding to multiple mentions of a keyword of interest 112 in an audio recording 136, according to some example implementations. Specifically, FIG. 3B shows a playlist 144B. Playlist 144B includes data that identifies an excerpt 248A, and data that identifies an excerpt 248B, each of which have been described previously. Notably, however, 1) data that identifies an excerpt 248A and data that identifies an excerpt 248B both include the identifier 102A; and 2) data to locate the excerpt 256A and data to locate the excerpt 256B both include the identifier 260A for a keyword of interest. Put differently, 1) both data that identifies an excerpt 248A and data that identifies an excerpt 248B include the same identifier 102 for an audio recording (e.g., “VC-00000013”); and 2) both data to locate the excerpt 256A and data to locate the excerpt 256B include an identifier for the same keyword of interest (e.g., a keyword with a value of “Comp. 1”). Thus, playlist 144B may represent a playlist 144 that identifies two excerpts that include mentions of the same keyword 110 in the same audio recording 136.

A playlist 144B that includes multiple excerpts corresponding to multiple mentions of a keyword of interest 112 in an audio recording 136 may be created in different situations. In one situation, a playlist 144B is created when a user makes selections: 1) of an audio recording 136 for playback by a media player 100; 2) identifying a keyword of interest 112; and 3) of a UI element 114. This situation might occur when media player 100 is configured such that selection of UI element 114 creates a playlist with the first n mentions of a keyword of interest 112 from an audio recording 136 (where n is a positive integer).

Referring back to FIG. 1C, these selections may be accepted from the user in block 154, block 158, and block 166 respectively. Block 170 may then be performed. In the example shown in FIG. 1A, keyword of interest 112 has the value “Comp. 1.” Thus, in one implementation, in block 172, an identifier 102 for the first audio recording 136 with a value of “VC-00000013” is added to a playlist 144B as identifier 102A, and in block 174, 1) an identifier 260A for a keyword of interest with a value of “Comp. 1” is added to the playlist 144B; and 2) an indication of a position of the mention 264 of the keyword of interest 112 in the audio recording 136 (e.g., an index 266; an offset 268; etc.) is included in the playlist 144B. In block 184, data that identifies a second excerpt 248B, from the second audio recording 136, that includes a mention of a second keyword of interest 112, is added to the playlist 144B.

Put differently, 1) the first audio recording 136 and the second audio recording 136 are the same (i.e., identified by the same identifier 102 with a value of “VC-00000013”); and 2) the second keyword of interest 112 and the first keyword of interest 112 are the same (i.e., have the same value of “Comp. 1”). In one implementation, block 184 includes block 186, and the value of “VC-00000013” is added to data that identifies an excerpt 248B. In another implementation, block 184 need not be executed because in playlist 144B, data that identifies an excerpt 248A and data that identifies an excerpt 248B each include the same identifier 102A for the audio recording 136. For example, playlist 144B may be stored such that both data that identifies an excerpt 248A and data that identifies an excerpt 248B are associated with the one identifier 102A for an audio recording 136. In one implementation, block 184 includes block 188. In block 188, data to locate the second excerpt (i.e., of the n excerpts) in the second audio recording (i.e., audio recording 136 with an ID with a value of “VC-00000013”) is added to playlist 144B (e.g., an index 266B; an offset 268B; etc.).

In another situation, a playlist 144B is created when a user makes selections: 1) of an audio recording 136 for playback by a media player 100 for playing audio; 2) identifying a keyword of interest 112; 3) of a caret 116 in the media player 100 from carets 116 that indicate mentions of the keyword of interest 112 in the audio recording 136; and 4) of a UI element 114.

Additionally, or alternatively, a playlist 144B may be created when a user selects multiple carets 116 in media player 100 and selects UI element 114. Specifically, a playlist 144B may be created when a user makes selections: 1) of an audio recording 136 for playback by a media player 100; 2) identifying a keyword of interest 112; 3) of multiple of carets 116A-C that indicate mentions of the keyword of interest 112 in the audio recording 136; and 4) of a UI element 114. Referring back to FIG. 1C, these selections may be accepted from the user in block 154, block 158, block 162, and block 166 respectively. Block 170 may then be performed, as described previously. Block 184 may be performed with respect to each selection of a caret 116; i.e., 1) block 186 is optionally performed, and the value of “VC-00000013” is added to data that identifies an excerpt 248B; and 2) block 188 is performed, and data to locate the excerpt 256B in the audio recording 136 is added to the playlist 144B, where the data corresponds to an indication of a position of a mention 264B for the caret 116 (e.g., an index 266, an offset 268).

Multiple Audio Recordings

In some implementations, playlist 144 includes data that identifies excerpts 248 in multiple audio recordings 136. FIG. 3C is a diagram that shows a data structure for a playlist 144 that includes multiple excerpts corresponding to multiple mentions of a keyword of interest 112 in multiple audio recordings 136, according to some example implementations. Specifically, FIG. 3C shows a playlist 144C. Playlist 144C includes data that identifies an excerpt 248A, and data that identifies an excerpt 248B, each of which have been described previously. Notably, however, data to locate the excerpt 256A and data to locate the excerpt 256B both include the identifier 260A for a keyword of interest. Put differently, both data to locate the excerpt 256A and data to locate the excerpt 256B include an identifier for the same keyword of interest (e.g., a keyword with a value of “Comp. 1”). Thus, playlist 144C may represent a playlist 144 that identifies two excerpts that include mentions of the same keyword 110 in different audio recordings 136.

A playlist 144C that includes excerpts corresponding to multiple mentions of the same keyword of interest 112 in multiple audio recording 136 may be created in different situations. For example, a user of media player 100 might cause a search to be performed for audio recordings 136 that include one or more mentions of the keyword of interest 112, and make selections of audio recordings 136 from the results of that search (e.g., from search results 520A-G shown in FIG. 5A). In one situation, a playlist 144C is created when a user makes the following selections: 1) of an audio recording 136 for playback by a media player 100 for playing audio; 2) identifying a keyword of interest 112; 3) of a UI element 114; 4) of another audio recording 136; 5) identifying the same keyword of interest 112; and 6) of the UI element 114.

Referring back to FIG. 1C, these selections may be accepted from the user in block 154, block 158, block 166, block 176, block 178, and block 180, respectively. Block 170 and block 184 may then be performed, as described previously.

Multiple Keywords

One Audio Recording

In some implementations, playlist 144 includes data that identifies multiple excerpts that include different keywords of interest 112. FIG. 3D is a diagram that shows a data structure for a playlist 144 that includes multiple excerpts corresponding to multiple mentions of multiple keywords of interest 112 in an audio recording 136, according to some example implementations. Specifically, FIG. 3D shows a playlist 144D. Playlist 144D includes data that identifies an excerpt 248A, and data that identifies an excerpt 248B, each of which have been described previously. Data that identifies an excerpt 248A and data that identifies an excerpt 248B both include the identifier 102A for an audio recording 136 as shown in FIG. 3B. In FIG. 3D, however, identifier 260A for a keyword of interest and identifier 260B for a keyword of interest are different (i.e., have different values). Put differently, 1) both data that identifies an excerpt 248A and data that identifies an excerpt 248B include the same identifier 102A for an audio recording 136 (e.g., “VC-00000013”); and 2) data to locate the excerpt 256A and data to locate the excerpt 256B include an identifier 260 for a different keyword of interest 112 (e.g., a keyword “Comp. 1” and a keyword “Product 1” respectively). Thus, playlist 144D may represent a playlist 144 that identifies two excerpts that include mentions of different keywords 110 in the same audio recording 136.

A playlist 144D that includes excerpts corresponding to mentions of different keywords of interest 112 in an audio recording 136 may be created in different situations. For example, a user of media player 100 might make selections that identify multiple keywords of interest 112 (i.e., select multiple UI elements 108) when an audio recording 136 is selected. In one situation, a playlist 144D is created when a user makes the following selections: 1) of an audio recording 136 for playback by a media player 100; 2) identifying a first keyword of interest 112; 3) identifying a second keyword of interest 112; and 4) of the UI element 114. Referring back to FIG. 1C, these selections may be accepted from the user in block 154, block 158, block 166, and block 178, respectively. Responsive to the selection of UI element 114, the following operations may be performed: 1) adding data that identifies a first excerpt 248A to playlist 144D in respect of the first keyword of interest 112 (e.g., in block 170, as previously described referring to FIG. 3A); and 2) adding data that identifies an excerpt 248B to playlist 144D in respect of the second keyword of interest 112 (e.g., in block 184).

For another example, a playlist 144D may be created when a user makes selections 1) of an audio recording 136 for playback by a media player 100; 2) identifying a first keyword of interest 112; 3) of a caret 116 in the media player 100 that indicates a mention of the first keyword of interest 112; 4) identifying a second keyword of interest 112; 5) of a caret 116 in the media player 100 that indicates a mention of the second keyword of interest 112; and 6) of the UI element 114. Referring back to FIG. 1C, these selections may be accepted from the user in block 154, block 158, block 162, block 178, block 179, and block 180, respectively. Responsive to the selection of UI element 114, the following operations may be performed 1) adding data that identifies a first excerpt 248A to playlist 144D in respect of the first keyword of interest 112 and corresponding caret 116 (e.g., in block 170, as previously described referring to FIG. 3A); and 2) adding data that identifies an excerpt 248B to playlist 144D in respect of the second keyword of interest 112 and corresponding caret 116 (e.g., in block 184).

Multiple Audio Recordings

In some implementations, playlist 144 includes data that identifies multiple excerpts, from different audio recordings 136, that include different keywords of interest 112. An example of such a playlist 144 can be described referring back to FIG. 2A, which has been described previously.

An example of a user creating such a playlist 144 is when a user of media player 100 makes selections that identify multiple keywords of interest 112 (i.e., select multiple UI elements 108) when different audio recordings 136 are selected; e.g., when a user makes the following selections: 1) of an audio recording 136 for playback by a media player 100; 2) identifying a keyword of interest 112; 3) of a UI element 114; 4) of another audio recording 136; 5) identifying another keyword of interest 112; and 6) of the UI element 114. Referring back to FIG. 1C, these selections may be accepted from the user in block 154, block 158, block 166, block 176, block 178, and block 180, respectively. Block 170 and block 184 may then be performed, as described previously.

Use of Positions

Referring back to FIG. 2B, in some implementations, data to locate the excerpt 256 in the audio recording 136 includes an indication of a position of a mention 264 of the keyword of interest 112 in the audio recording 136. For data to locate the excerpt 256 in the audio recording 136, an implementation might store 1) an identifier 260 for a keyword of interest, and 2) an index 266 of the mention of the keyword 110 in the audio recording 136. Another implementation might 1) forego storing an identifier 260 for a keyword of interest, and 2) store an offset 268 (e.g., relative to a beginning of the audio recording 136). Storing an identifier 260 for a keyword of interest in data that identifies an excerpt 248 provides an advantage in that the identifier may later be used; e.g., when playing back the playlist 144. However, storing only an offset 268, such as relative to a beginning (e.g., the start, the end) of the audio recording, may facilitate playback of the playlist 144 by a media player that does not support playback based on an identifier 260 of a keyword of interest and an index 266 of the mention of the keyword in the audio recording. In different implementations, an offset may be stored as different types of data. For example, one implementation may store an offset 268 as a time offset (e.g., a timestamp). Another implementation may store an offset 268 as a data offset (e.g., in bytes, in packets, etc.).

An indication of a position of a mention 264 might correspond to different positions relative to an excerpt. For example, an indication of a position of a mention 264 may correspond to a starting position for an excerpt, an ending position for an excerpt, a position of a mention of a keyword of interest 112 in an excerpt, etc. In one implementation, an indication of a position of a mention 264 is a predetermined period of time (e.g., 5 s, 10 s, etc.) before the mention of the keyword of interest 112 in an audio recording 136. In another implementation, an indication of a position of a mention 264 is such that the excerpt includes a start of a sentence, a start of a paragraph, etc. that includes the mention. Such implementations provide more context around a mention of a keyword 110 in an excerpt, in turn making the excerpt more useful.

Using a Playlist

Implementations may support various uses for a playlist 144, such as a media player (such as media player 100) playing back a playlist 144, creating an audio recording 136 based on a playlist 144, and/or creating a transcript 138 based on a playlist 144.

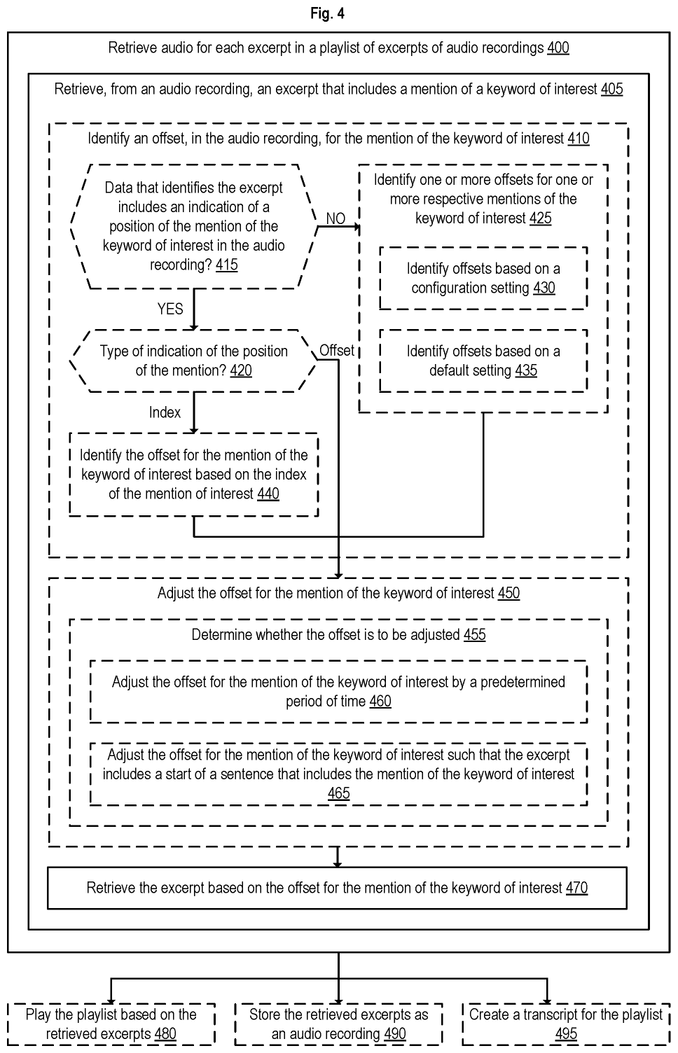

FIG. 4 is a flow diagram that shows a method for retrieving audio for excerpts in a playlist 144 of excerpts, according to some example implementations. FIG. 4 includes block 400, which includes retrieving audio for each excerpt in a playlist 144 of excerpts of audio recordings 136. Block 400 includes block 405.

Block 405 includes retrieving an excerpt, from an audio recording 136, that includes a mention of a keyword of interest 112. Block 405 includes block 410, block 450, and block 470.

In block 410, an offset 268, in the audio recording 136, is identified for the mention of the keyword of interest 112. In some implementations, block 410 includes one or more of block 415, block 420, block 425, and block 440.

Block 415 includes determining whether data that identifies the excerpt 248 includes an indication of a position of the mention 264 of the keyword of interest 112 in the audio recording 136. Responsive to determining that the data that identifies the excerpt 248 does include an indication of a position of the mention 264, flow passes from block 415 to block 420. In contrast, responsive to determining that the data that identifies the excerpt 248 does not include an indication of a position of the mention 264, flow passes from block 415 to block 425.

In block 425, one or more offsets 268 are identified for one or more respective mentions of the keyword of interest 112. For example, a playlist 144 may store an identifier 260 for a keyword of interest and not an indication of a position of a mention 264 (e.g., as discussed referring to FIG. 3A and playlist 144A). In one implementation, offsets 268 are identified for all mentions of the keyword of interest 112 in the audio recording 136. In another implementation, offsets 268 are identified for the first n mentions of the keyword of interest 112 (where n is a positive integer). An implementation may identify offsets 268 (e.g., for all mentions of the keyword of interest 112, for the first n mentions of the keyword of interest 112, etc.) based on 1) a configuration setting (block 430), and/or on a default setting (block 435). In one implementation, an offset 268 can be identified for a mention of a keyword 110 based on the index 266 of the mention of the keyword 110 in the audio recording 136. For example, metadata 142 for an audio recording 136 (as shown in FIG. 1B) may associate one or more keywords 110 with corresponding indexes 266 of the mentions of the keywords 110, and the indexes 266 with corresponding offsets 268 in the audio recording 136. From block 425, flow passes to block 450.

Block 420 includes determining a type of the indication of the position of the mention 264. Responsive to determining that the type of the indication of the position of the mention 264 is an index 266 (i.e., of the mention of the keyword 110 in the audio recording 136), flow passes from block 420 to block 440. Responsive to determining that the type of the indication of the position of the mention 264 is an offset 268, flow passes from block 420 to block 450.

In block 440, the offset 268 for the mention of the keyword of interest 112 is identified based on the index 266 of the mention of the keyword of interest 112. In one implementation, the offset 268 is identified from metadata 142 for an audio recording 136, as previously discussed. From block 440, flow passes to block 450.

In block 450, the offset 268 for the mention of the keyword of interest 112 is optionally adjusted. Block 450 includes block 455, in which whether the offset 268 is to be adjusted is determined. Whether the offset 268 is to be adjusted may be determined in different ways. In one implementation, data that identifies an excerpt 248 includes a flag that indicates whether an indication of a position of the mention 264 has been adjusted (e.g., by a predetermined period of time, such as to include a sentence that includes the mention of the keyword of interest 112, etc.), and whether the offset 268 is to be adjusted may be determined based on a value of the flag (e.g., the flag is not to be adjusted if the flag indicates that the offset 268 has already been adjusted, and the flag is to be adjusted if the flag indicates that the offset 268 has not already been adjusted). In another implementation, whether the offset 268 is to be adjusted is based on a configuration or a default setting. For example, a configuration or default setting may indicate that an offset 268 is to be adjusted if an excerpt does not include a predetermined period of time before the mention of the keyword 110, or if an excerpt does not include a start of a sentence that includes the mention of the keyword 110. Additionally, or alternatively, an implementation may detect whether an excerpt includes a predetermined period of time before the mention of the keyword 110, or a start of a sentence that includes the mention of the keyword 110, and determine whether the offset 268 is to be adjusted accordingly. For example, an implementation may retrieve the excerpt based on an unadjusted offset 268 for the mention of the keyword of interest 112 and analyze the audio to determine the position of the mention in the excerpt (e.g., in the beginning of the excerpt, after a period of time, at the start of a sentence, etc.), then determine whether the offset 268 is to be adjusted.

In one implementation, block 450 includes block 460. In block 460, responsive to determining that the offset 268 is to be adjusted, the offset 268 for the mention of the keyword of interest 112 is adjusted by a predetermined period of time. Implementations may adjust an offset 268 by a predetermined period of time in different ways (e.g., if the offset 268 is a time offset, by subtracting the predetermined period of time from the offset 268; if the offset 268 is a data offset, by identifying an amount of data that corresponds to the predetermined period of time and subtracting that from the offset 268, etc.).

In another implementation, block 450 includes block 465. In block 465, responsive to determining that the offset 268 is to be adjusted, the offset 268 is adjusted such that the excerpt includes a start of a sentence that includes the mention of the keyword of interest 112. Implementations may adjust an offset 268 such that the excerpt includes a start of a sentence in different ways (e.g., by analyzing the audio to determine a start of the sentence and determining the offset 268 of the start of the sentence; analyzing a transcript for the audio recording 136 to determine a start of the sentence and determining the offset 268 of the start of the sentence, etc.). From block 465, flow passes to block 470.

In block 470, the excerpt is retrieved based on the offset 268 for the mention of the keyword of interest 112. In some implementations, retrieving the excerpt includes retrieving the audio recording 136 identified by the identifier 102 for the audio recording 136 (e.g., from a server 130 as shown in FIG. 1B). In other implementations, retrieving the excerpt includes retrieving the excerpt based on the offset 268 for the mention of the keyword of interest 112 and on another offset 268 (e.g., where the offset corresponds to a start of the excerpt, and the other offset corresponds to an end of the excerpt) or on a duration, where the other offset or duration is based on 1) a default or configurable predetermined interval of time (e.g., 15 seconds); 2) a sentence, a paragraph, a portion of the audio that the participant is talking, etc.

Playback of a Playlist

In one implementation, a playlist 144 can be played back in block 480 based on the excerpts retrieved in block 470. In another implementation, block 470 and block 400 are executed concurrently. For example, an implementation may play back, or buffer for later playback, audio for an excerpt after the excerpt is retrieved in block 470 and before all the excerpts of a playlist 144 are retrieved in block 400.

Different implementations may include support for block 400 in a media player 100 (e.g., in code 124 as shown in FIG. 1B). Alternatively, an implementation may include support for block 400 in an add-on or extension to a media player that otherwise does not support playback of a playlist 144 of excerpts of audio recordings 136.

Creation of an Audio Recording

Implementations may also support a playlist 144 being stored as an audio recording 136 in block 490 based on the excerpts retrieved in block 470. Such implementations may discard the remainder of the audio recordings 136 on which the excerpts are based. Such an implementation is advantageous in that it reduces the storage used to store the excerpts from the audio recordings 136, in turn improving the performance of and/or reducing the requirements of the electronic devices (e.g., server 130) and networks used for this purpose.

Creating a Transcript

Implementations may also support a transcript being created for a playlist 144, in block 495. Referring back to FIG. 1B, in one implementation, a transcript 138 is retrieved for an audio recording 136 from which an excerpt is retrieved (e.g., in block 405). Creating the transcript for the playlist 144 may include adding, to the transcript for the playlist 144, a portion of the transcript 138 for the audio recording 136 that corresponds to the excerpt of the audio recording 136. Thus, for a playlist 144 that includes two excerpts (for first and second audio recordings 136 respectively), creating the transcript for the playlist 144 includes adding, to the transcript for the playlist: 1) a first portion of a transcript for the first audio recording that corresponds to the first excerpt of the first audio recording 136; and 2) a second portion of a transcript for the second audio recording that corresponds to the second excerpt of the second audio recording 136.

It should be noted that a portion of a transcript corresponding to an excerpt might include a sentence, a paragraph, etc. that includes the mention of a keyword of interest 112. In one implementation, this inclusion in the portion of the transcript is regardless whether the excerpt includes the sentence, the paragraph, etc. Put differently, an implementation may support including fewer, more, or the same words or utterances in a portion of a transcript corresponding to an excerpt than the words or utterances spoken in the excerpt. For example, an implementation may support including, in a portion of a transcript corresponding to an excerpt, a whole sentence that includes a mention of a keyword of interest 112 regardless whether the excerpt includes the whole sentence.

Other Functionality

Selection Via Search Results

FIG. 5A is a diagram that shows a graphical user interface that allows a user to search for audio recordings that include mentions of a keyword, according to some implementations. Specifically, FIG. 5A shows a graphical user interface 500. A graphical user interface (GUI) is a UI that allows a user to interact with an electronic device through graphical elements, as opposed to other forms of user interface (e.g., a command-line interface). The terms GUI and UI, and thus GUI element and UI element, are used interchangeably herein.

GUI 500 includes UI element 505, UI element 510, and UI element 515. In one implementation, UI element 505 is a search bar that allows a user to perform a search for audio recordings 136 that include one or more mentions of the keyword of interest 112. As shown in FIG. 5A, UI element 505 includes the text “Keyword/Keyphrase” (e.g., to indicate that the user may enter a keyword of interest 112 in UI element 505) and the entered text “Competitor 1” corresponding to keyword of interest 112.

UI element 510 allows a user to filter search results 520, before or after a search is performed, such that the search results 520 include only one or more participants selected in UI element 510. For example, in one implementation, a user may select in UI element 510 an identifier for a participant (i.e., “Kathy” or “Jesse” as shown in FIG. 1A) or a group of participants (e.g., a team of agents in a call center, such as “My Team” as shown in FIG. 5A) such that search results 520 only include audio recordings 136 in which one of the participants are identified as a speaker.

UI element 515 allows a user to filter search results 520, before or after a search is performed, such that the search results 520 include only one or more audio recordings 136 that are dated in a selected period of time. For example, in one implementation, a user may select in UI element 515 a period of time (e.g., 1 hour, 4 hours, 1 day, 2 days, 5 days, 1 week, etc.), such that search results 520 only include audio recordings 136 that are dated in that period of time (e.g., the audio recordings 136 are stored in that period of time, concluded in that period of time, etc.).

Referring to FIG. 5B, in one implementation, responsive to a user entering a keyword of interest 112 (or part thereof), GUI 500 causes block 545 to be performed; i.e., a search to be performed for the user, based on the keyword of interest 112. In one implementation, GUI 500 displays search results 520A-G corresponding to audio recordings 136 that include mentions of the entered keyword of interest 112. In the example shown in FIG. 5A, search results 520A-G may include information for each audio recording 136 included in the search results 520 under different headings, such as 1) “Call Name” (which may represent an identifier 102 for the audio recording 136); 2) “Date” (which may represent when the audio recording 136 was stored, when the audio recording 136 was made, etc.); 3) “Duration” (which may represent a duration of the audio recording 136); 4) “Account” (which may represent an account in a customer relationship management (CRM) system with which the audio recording 136 is related); 5) “Team Member” (which may represent a member of a call center team who was a participant on a call to which audio recording 136 corresponds); and 6) “Review.” Other implementations may include none, some, or all of these headings, and/or other headings (e.g., a heading for one or more call statistics (e.g., a talk/listen ratio), a heading for keywords 110 mentioned in the audio recording 136, a heading for a rating for the call, etc.).

The column under the heading “Review” for search results 520A-G includes, for each search result 520, a respective one of user interface elements 525A-G. In one implementation, each of UI elements 525 allows a user to select the audio recording 136 to which that search result 520 corresponds. For example, selecting the top-most UI element 525A shown in FIG. 5A allows a user to select the audio recording 136 with an identifier “Roger Smith 09/25/19 2” (i.e., from search result 520A). Also, in one implementation, each of UI elements 525 allows a user to select the audio recording 136 to which that search result 520 corresponds, as well as the entered keyword of interest 112. Using the previous example, such an implementation allows a user to select the top-most UI element 525A and thus select the audio recording 136 with an identifier “Roger Smith 09/25/19 2” and identify a keyword of interest “Competitor 1.”

Referring to FIG. 5B, flow passes from block 545 to block 150, which has been described previously. In one implementation, referring back to FIG. 1C, a UI element 525 for a search result 520 allows a user to make a selection of an audio recording 136 for playback by a media player 100 for playing audio (e.g., a selection that is accepted in block 154 and/or block 176), and a selection that identifies a keyword of interest 112 (e.g., a selection that is accepted in block 158 and/or block 178). Allowing a user to make such selections based on search results 520 facilitates creating a playlist based on a given keyword of interest 112 because a user can search for the keyword of interest 112, view search results 520, and create a playlist 144 based thereon. In one implementation, a GUI 500 includes a UI element that allows a user to automatically create a playlist 144 based on search results 520 by selecting the UI element and without further selections (i.e., wherein the playlist 144 includes excerpts corresponding to mentions of the keyword of interest 112 in each of the search results 520).

Example Electronic Devices and Environments

Electronic Device and Machine-Readable Media

One or more parts of the above implementations may include software and/or a combination of software and hardware. An electronic device (also referred to as a computing device, computer, etc.) includes hardware and software, such as a set of one or more processors coupled to one or more machine-readable storage media (e.g., magnetic disks, optical disks, read only memory (ROM), Flash memory, phase change memory, solid state drives (SSDs)) to store code (which is composed of software instructions and which is sometimes referred to as computer program code or a computer program) for execution on the set of processors and/or to store data. For instance, an electronic device may include non-volatile memory (with slower read/write times, e.g., magnetic disks, optical disks, read only memory (ROM), Flash memory, phase change memory, SSDs) and volatile memory (e.g., dynamic random access memory (DRAM), static random access memory (SRAM)), where the non-volatile memory persists code/data even when the electronic device is turned off or when power is otherwise removed, and the electronic device copies that part of the code that is to be executed by the set of processors of that electronic device from the non-volatile memory into the volatile memory of that electronic device during operation because volatile memory typically has faster read/write times. As another example, an electronic device may include a non-volatile memory (e.g., phase change memory) that persists code/data when the electronic device is turned off, and that has sufficiently fast read/write times such that, rather than copying the part of the code/data to be executed into volatile memory, the code/data may be provided directly to the set of processors (e.g., loaded into a cache of the set of processors); in other words, this non-volatile memory operates as both long term storage and main memory, and thus the electronic device may have no or only a small amount of volatile memory for main memory. In addition to storing code and/or data on machine-readable storage media, typical electronic devices can transmit code and/or data over one or more machine-readable transmission media (also called a carrier) (e.g., electrical, optical, radio, acoustical or other form of propagated signals—such as carrier waves, infrared signals). For instance, typical electronic devices also include a set of one or more physical network interface(s) to establish network connections (to transmit and/or receive code and/or data using propagating signals) with other electronic devices. Thus, an electronic device may store and transmit (internally and/or with other electronic devices over a network) code and/or data with one or more machine-readable media (also referred to as computer-readable media).

Electronic devices (also referred to as devices) are designed for and/or used for a variety of purposes, and different terms may reflect those purposes (e.g., user devices, network devices). Some user devices are designed to mainly be operated as servers (sometime referred to as server devices), while others are designed to mainly be operated as clients (sometimes referred to as client devices, client computing devices, client computers, or end user devices; examples of which include desktops, workstations, laptops, personal digital assistants, smartphones, wearables, augmented reality (AR) devices, virtual reality (VR) devices, etc.). The software executed to operate a user device (typically a server device) as a server may be referred to as server software or server code), while the software executed to operate a user device (typically a client device) as a client may be referred to as client software or client code. A server provides one or more services to (also referred to as serves) one or more clients.

The term “user” refers to an entity (e.g., an individual person) that uses an electronic device, and software and/or services may use credentials to distinguish different accounts associated with the same and/or different users. Users can have one or more roles, such as administrator, programmer/developer, and end user roles. As an administrator, a user typically uses electronic devices to administer them for other users, and thus an administrator often works directly and/or indirectly with server devices and client devices.

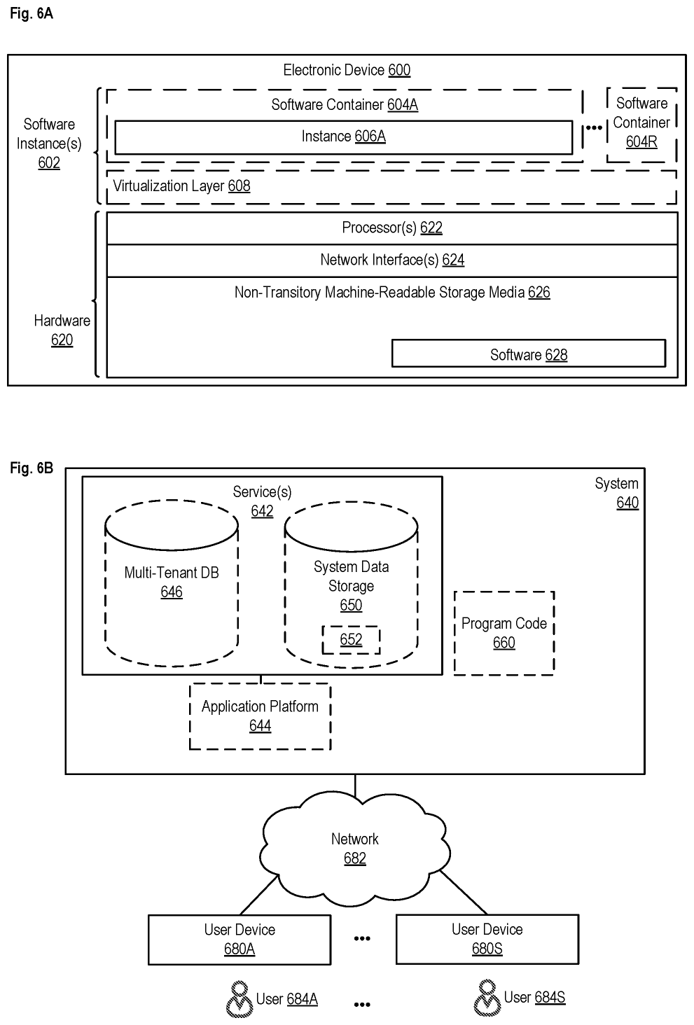

FIG. 6A is a block diagram illustrating an electronic device 600 according to some example implementations. FIG. 6A includes hardware 620 comprising a set of one or more processor(s) 622, a set of one or more network interfaces 624 (wireless and/or wired), and non-transitory machine-readable storage media 626 having stored therein software 628 (which includes instructions executable by the set of one or more processor(s) 622). One or more of the implementations described herein may be implemented as a service (e.g., a media player service). Each of the previously described media player 100, code 124, code 132, datastore 134, and metadata repository 140 may be implemented in one or more electronic devices 600. In one implementation, code 124 is part of a media player 100 that offers a media player service, and code 132, datastore 134, and metadata repository 140 are implemented as one or more separate services. In another implementation, media player 100, code 124, and code 132 is part of a media player that offers a media player service, and datastore 134 and metadata repository 140 are implemented as one or more separate services. In one implementation, the playlist service is available to one or more clients (such as a media player). In one implementation: 1) each of the clients is implemented in a separate one of the electronic devices 600 (e.g., in end user devices where the software 628 represents the software to implement clients to interface directly and/or indirectly with the media player service (e.g., software 628 represents a web browser, a native client, a portal, a command-line interface, and/or an application programming interface (API) based upon protocols such as Simple Object Access Protocol (SOAP), REpresentational State Transfer (REST), etc.)); 2) the media player service is implemented in a separate set of one or more of the electronic devices 600 (e.g., a set of one or more server devices where the software 628 represents the software to implement the media player service); and 3) in operation, the electronic devices implementing the clients and the media player service would be communicatively coupled (e.g., by a network) and would establish between them (or through one or more other layers and/or or other services) connections for submitting selections and/or other data to the media player service and returning data to the clients. Other configurations of electronic devices may be used in other implementations (e.g., an implementation in which the client and the media player service are implemented on a single electronic device 600).

During operation an instance of the software 628 (illustrated as instance 606A and also referred to as a software instance; and in the more specific case of an application, as an application instance) is executed. In electronic devices that use compute virtualization, the set of one or more processor(s) 622 typically execute software to instantiate a virtualization layer 608 and software container(s) 604A-R (e.g., with operating system-level virtualization, the virtualization layer 608 may represent a container engine (such as Docker Engine by Docker, Inc. or rkt in Container Linux by Red Hat, Inc.) running on top of (or integrated into) an operating system, and it allows for the creation of multiple software containers 604A-R (representing separate user space instances and also called virtualization engines, virtual private servers, or jails) that may each be used to execute a set of one or more applications; with full virtualization, the virtualization layer 608 represents a hypervisor (sometimes referred to as a virtual machine monitor (VMM)) or a hypervisor executing on top of a host operating system, and the software containers 604A-R each represent a tightly isolated form of a software container called a virtual machine that is run by the hypervisor and may include a guest operating system; with para-virtualization, an operating system and/or application running with a virtual machine may be aware of the presence of virtualization for optimization purposes). Again, in electronic devices where compute virtualization is used, during operation an instance of the software 628 is executed within the software container 604A on the virtualization layer 608. In electronic devices where compute virtualization is not used, the instance 606A on top of a host operating system is executed on the “bare metal” electronic device 600. The instantiation of the instance 606A, as well as the virtualization layer 608 and software containers 604A-R if implemented, are collectively referred to as software instance(s) 602.

Alternative implementations of an electronic device may have numerous variations from that described above. For example, customized hardware and/or accelerators might also be used in an electronic device.

Example Environment

FIG. 6B is a block diagram of a deployment environment according to some example implementations. A system 640 includes hardware (e.g, a set of one or more server devices) and software to provide service(s) 642, including the media player service. In some implementations the system 640 is in one or more datacenter(s). These datacenter(s) may be: 1) first party datacenter(s), which are datacenter(s) owned and/or operated by the same entity that provides and/or operates some or all of the software that provides the service(s) 642; and/or 2) third party datacenter(s), which are datacenter(s) owned and/or operated by one or more different entities than the entity that provides the service(s) 642 (e.g., the different entities may host some or all of the software provided and/or operated by the entity that provides the service(s) 642). For example, third party datacenters may be owned and/or operated by entities providing public cloud services (e.g., Amazon.com, Inc. (Amazon Web Services), Google LLC (Google Cloud Platform), Microsoft Corporation (Azure)).

The system 640 is coupled to user devices 680A-S over a network 682. The service(s) 642 may be on-demand services that are made available to one or more of the users 684A-S working for one or more entities other than the entity which owns and/or operates the on-demand services (those users sometimes referred to as outside users) so that those entities need not be concerned with building and/or maintaining a system, but instead may make use of the service(s) 642 when needed (e.g., when needed by the users 684A-S). The service(s) 642 may communicate with each other and/or with one or more of the user devices 680A-S via one or more APIs (e.g., a REST API). The user devices 680A-S are operated by users 684A-S.

In some implementations the system 640 is a multi-tenant system (also known as a multi-tenant architecture). The term multi-tenant system refers to a system in which various elements of hardware and/or software of the system may be shared by one or more tenants. A multi-tenant system may be operated by a first entity (sometimes referred to a multi-tenant system provider, operator, or vendor; or simply a provider, operator, or vendor) that provides one or more services to the tenants (in which case the tenants are customers of the operator and sometimes referred to as operator customers). A tenant includes a group of users who share a common access with specific privileges. The tenants may be different entities (e.g., different companies, different departments/divisions of a company, and/or other types of entities), and some or all of these entities may be vendors that sell or otherwise provide products and/or services to their customers (sometimes referred to as tenant customers). A multi-tenant system may allow each tenant to input tenant specific data for user management, tenant-specific functionality, configuration, customizations, non-functional properties, associated applications, etc. A tenant may have one or more roles relative to a system and/or service. For example, in the context of a CRM system or service, a tenant may be a vendor using the CRM system or service to manage information the tenant has regarding one or more customers of the vendor. As another example, in the context of Data as a Service (DAAS), one set of tenants may be vendors providing data and another set of tenants may be customers of different ones or all of the vendors' data. As another example, in the context of Platform as a Service (PAAS), one set of tenants may be third party application developers providing applications/services and another set of tenants may be customers of different ones or all of the third-party application developers.

Multi-tenancy can be implemented in different ways. In some implementations, a multi-tenant architecture may include a single software instance (e.g., a single database instance) which is shared by multiple tenants; other implementations may include a single software instance (e.g., database instance) per tenant; yet other implementations may include a mixed model; e.g., a single software instance (e.g., an application instance) per tenant and another software instance (e.g., database instance) shared by multiple tenants.

In one implementation, the system 640 is a multi-tenant cloud computing architecture supporting multiple services, such as one or more of the following:

| Type of Service | Example Service(s) by salesforce.com, inc. |
|---|---|
| Customer relationship management (CRM) | Sales Cloud, media player service |
| Configure, price, quote (CPQ) | CPQ and Billing |
| Business process modeling (BPM) | Process Builder |
| Customer support | Service Cloud, Field Service Lightning |
| Marketing | Commerce Cloud Digital, Commerce Cloud |
| | Order Management, Commerce Cloud Store |
| External data connectivity | Salesforce Connect |
| Productivity | Quip |
| Database-as-a-Service | Database.com ™ |
| Data-as-a-Service (DAAS or DaaS) | Data.com |
| Platform-as-a-service (PAAS or PaaS) | Heroku ™ Enterprise, Thunder, Force.com ®, |
| | Lightning |
| Infrastructure-as-a-Service (IAAS or IaaS) | |
| (e.g., virtual machines, servers, and/or | |
| storage) | |
| Analytics | Einstein Analytics, Sales Analytics, Service |
| | Analytics |
| Community | Community Cloud, Chatter |
| Internet-of-Things (IoT) | Salesforce IoT, IoT Cloud |
| Industry-specific | Financial Services Cloud, Health Cloud |
| Artificial intelligence (AI) | Einstein |
| Application marketplace (“app store”) | AppExchange, AppExchange Store Builder |
| Data modeling | Schema Builder |
| Security | Salesforce Shield |
| Identity and Access Management (IAM) | Field Audit Trail, Platform Encryption, IT |
| | Governance, Access Management, Salesforce |
| | Identity, Salesforce Authenticator |

For example, system 640 may include an application platform 644 that enables PAAS for creating, managing, and executing one or more applications developed by the provider of the application platform 644, users accessing the system 640 via one or more of user electronic devices 680A-S, or third-party application developers accessing the system 640 via one or more of user electronic devices 680A-S.

In some implementations, one or more of the service(s) 642 may use one or more multi-tenant databases 646, as well as system data storage 650 for system data 652 accessible to system 640. In certain implementations, the system 640 includes a set of one or more servers that are running on server electronic devices and that are configured to handle requests for any authorized user associated with any tenant (there is no server affinity for a user and/or tenant to a specific server). The user electronic device 680A-S communicate with the server(s) of system 640 to request and update tenant-level data and system-level data hosted by system 640, and in response the system 640 (e.g., one or more servers in system 640) automatically may generate one or more Structured Query Language (SQL) statements (e.g., one or more SQL queries) that are designed to access the desired information from the one or more multi-tenant database 646 and/or system data storage 650.

In some implementations, the service(s) 642 are implemented using virtual applications dynamically created at run time responsive to queries from the user electronic devices 680A-S and in accordance with metadata, including: 1) metadata that describes constructs (e.g., forms, reports, workflows, user access privileges, business logic) that are common to multiple tenants; and/or 2) metadata that is tenant specific and describes tenant specific constructs (e.g., tables, reports, dashboards, interfaces, etc.) and is stored in a multi-tenant database. To that end, the program code 660 may be a runtime engine that materializes application data from the metadata; that is, there is a clear separation of the compiled runtime engine (also known as the system kernel), tenant data, and the metadata, which makes it possible to independently update the system kernel and tenant-specific applications and schemas, with virtually no risk of one affecting the others. Further, in one implementation, the application platform 644 includes an application setup mechanism that supports application developers' creation and management of applications, which may be saved as metadata by save routines. Invocations to such applications, including the media player service, may be coded using Procedural Language/Structured Object Query Language (PL/SOQL) that provides a programming language style interface. Invocations to applications may be detected by one or more system processes, which manages retrieving application metadata for the tenant making the invocation and executing the metadata as an application in a software container (e.g., a virtual machine).

Network 682 may be any one or any combination of a LAN (local area network), WAN (wide area network), telephone network, wireless network, point-to-point network, star network, token ring network, hub network, or other appropriate configuration. The network may comply with one or more network protocols, including an Institute of Electrical and Electronics Engineers (IEEE) protocol, a 3rd Generation Partnership Project (3GPP) protocol, a 4^{th} generation wireless protocol (4G) (e.g., the Long Term Evolution (LTE) standard, LTE Advanced, LTE Advanced Pro), a fifth generation wireless protocol (5G), and/or similar wired and/or wireless protocols, and may include one or more intermediary devices for routing data between the system 640 and the user electronic devices 680A-S.

Each user electronic device 680A-S (such as a desktop personal computer, workstation, laptop, Personal Digital Assistant (PDA), smart phone, augmented reality (AR) devices, virtual reality (VR) devices, etc.) typically includes one or more user interface devices, such as a keyboard, a mouse, a trackball, a touch pad, a touch screen, a pen or the like, video or touch free user interfaces, for interacting with a GUI provided on a display (e.g., a monitor screen, a liquid crystal display (LCD), a head-up display, a head-mounted display, etc.) in conjunction with pages, forms, applications and other information provided by system 640. For example, the user interface device can be used to access data and applications hosted by system 640, and to perform searches on stored data, and otherwise allow a user 684 to interact with various GUI pages that may be presented to a user 684. User electronic devices 680A-S might communicate with system 640 using TCP/IP (Transfer Control Protocol and Internet Protocol) and, at a higher network level, use other networking protocols to communicate, such as HyperText Transfer Protocol (HTTP), Andrew File System (AFS), Wireless Application Protocol (WAP), File Transfer Protocol (FTP), Network File System (NFS), an application program interface (API) based upon protocols such as SOAP, REST, etc. In an example where HTTP is used, one or more user electronic devices 680A-S might include an HTTP client, commonly referred to as a “browser,” for sending and receiving HTTP messages to and from server(s) of system 640, thus allowing users 684 of the user electronic device 680A-S to access, process and view information, pages and applications available to it from system 640 over network 682.

### CONCLUSION

In the above description, numerous specific details such as resource partitioning/sharing/duplication implementations, types and interrelationships of system components, and logic partitioning/integration choices are set forth in order to provide a more thorough understanding. The invention may be practiced without such specific details, however. In other instances, control structures, logic implementations, opcodes, means to specify operands, and full software instruction sequences have not been shown in detail since those of ordinary skill in the art, with the included descriptions, will be able to implement what is described without undue experimentation.

References in the specification to “one implementation,” “an implementation,” “an example implementation,” “some implementations,” “other implementations,” etc., indicate that the implementation(s) described may include a particular feature, structure, or characteristic, but every implementation may not necessarily include the particular feature, structure, or characteristic. Moreover, such phrases are not necessarily referring to the same implementation. Further, when a particular feature, structure, and/or characteristic is described in connection with an implementation, one skilled in the art would know to affect such feature, structure, and/or characteristic in connection with other implementations whether or not explicitly described.

For example, the figure(s) illustrating flow diagrams sometimes refer to the figure(s) illustrating block diagrams, and vice versa. Whether or not explicitly described, the alternative implementations discussed with reference to the figure(s) illustrating block diagrams also apply to the implementations discussed with reference to the figure(s) illustrating flow diagrams, and vice versa. At the same time, the scope of this description includes implementations, other than those discussed with reference to the block diagrams, for performing the flow diagrams, and vice versa.

Bracketed text and blocks with dashed borders (e.g., large dashes, small dashes, dot-dash, and dots) may be used herein to illustrate optional operations and/or structures that add additional features to some implementations. However, such notation should not be taken to mean that these are the only options or optional operations, and/or that blocks with solid borders are not optional in certain implementations.

The detailed description and claims may use the term “coupled,” along with its derivatives. “Coupled” is used to indicate that two or more elements, which may or may not be in direct physical or electrical contact with each other, co-operate or interact with each other.

While the flow diagrams in the figures show a particular order of operations performed by certain implementations, such order is exemplary and not limiting (e.g., alternative implementations may perform the operations in a different order, combine certain operations, perform certain operations in parallel, overlap performance of certain operations such that they are partially in parallel, etc.).

While the above description includes several example implementations, the invention is not limited to the implementations described and can be practiced with modification and alteration within the spirit and scope of the appended claims. The description is thus illustrative instead of limiting.

What is claimed is:

1. A non-transitory machine-readable storage medium that provides instructions that, when executed by a processor, are capable of causing the processor to perform operations comprising:
creating a playlist of excerpts from audio recordings, the creating including:
accepting, from a user, a selection of a first audio recording for playback by a media player for playing audio;
accepting, from the user, a selection that identifies a first keyword of interest;
accepting, from the user, a selection of a user interface element in the media player;
adding to the playlist, responsive to the selection of the user interface element, data that identifies a first excerpt, from the first audio recording, that includes a mention of the first keyword of interest, the adding the data that identifies the first excerpt including:
adding an identifier for the first audio recording; and
adding data to locate the first excerpt in the first audio recording;
accepting, from the user, a selection of a second audio recording for playback by the media player;
accepting, from the user, another selection of the user interface element in the media player; and
adding to the playlist, responsive to the another selection of the user interface element, data that identifies a second excerpt, from the second audio recording, that includes a mention of a second keyword of interest, the adding the data that identifies the second excerpt including:
adding an identifier for the second audio recording.

2. The non-transitory machine-readable storage medium of claim 1, wherein the first audio recording and the second audio recording are each of a conversation between an agent of a call center and a caller.

3. The non-transitory machine-readable storage medium of claim 1, wherein the data to locate the first excerpt in the first audio recording includes an identifier for the first keyword of interest, and wherein the first keyword of interest and the second keyword of interest are the same.

4. The non-transitory machine-readable storage medium of claim 1, wherein
the data to locate the first excerpt in the first audio recording includes an identifier for the first keyword of interest,
the adding the data that identifies the second excerpt further includes adding data to locate the second excerpt in the second audio recording,
the data to locate the second excerpt in the second audio recording includes an identifier for the second keyword of interest, and
the first keyword of interest is different from the second keyword of interest.

5. The non-transitory machine-readable storage medium of claim 1, wherein the data to locate the first excerpt in the first audio recording includes an identifier for the first keyword of interest and an indication of a position of the mention of the first keyword of interest in the first audio recording, and wherein the indication of the position is an index, as measured from a beginning of the first audio recording, of the mention of the first keyword of interest in mentions of the first keyword of interest in the first audio recording.

6. The non-transitory machine-readable storage medium of claim 1, wherein the data to locate the first excerpt in the first audio recording includes an indication of a position of the mention of the first keyword of interest in the first audio recording, and wherein the indication of the position is an offset relative to a beginning of the first audio recording.

7. The non-transitory machine-readable storage medium of claim 6, wherein the position corresponds to a starting position for the first excerpt, and wherein the starting position for the first excerpt is a predetermined period of time before the mention of the first keyword of interest.

8. The non-transitory machine-readable storage medium of claim 6, wherein the position corresponds to a starting position for the first excerpt, and wherein the starting position for the first excerpt is such that the first excerpt includes a start of a sentence that includes the mention.

9. The non-transitory machine-readable storage medium of claim 1, wherein the creating further includes:
accepting, from the user, a selection of a caret in the media player from carets that indicate mentions of the first keyword of interest in the first audio recording, wherein the selected caret indicates the mention included in the first excerpt.

10. The non-transitory machine-readable storage medium of claim 1, wherein the operations further comprise:
creating a transcript for the playlist, the creating the transcript including:
adding, to the transcript for the playlist, a first portion of a transcript for the first audio recording that corresponds to the first excerpt of the first audio recording, and
adding, to the transcript for the playlist, a second portion of a transcript for the second audio recording that corresponds to the second excerpt of the second audio recording.

11. The non-transitory machine-readable storage medium of claim 10, wherein the first portion of the transcript for the first audio recording includes a sentence that includes the mention of the first keyword of interest.

12. The non-transitory machine-readable storage medium of claim 1, wherein the operations further comprise:
performing, for the user, a search for audio recordings that include one or more mentions of the keyword of interest, wherein the selection of the first audio recording for playback is from results of the search.

13. A method comprising:
creating a playlist of excerpts from audio recordings, the creating including:
accepting, from a user, a selection of a first audio recording for playback by a media player for playing audio;
accepting, from the user, a selection that identifies a first keyword of interest;
accepting, from the user, a selection of a user interface element in the media player;
adding to the playlist, responsive to the selection of the user interface element, data that identifies a first excerpt, from the first audio recording, that includes a mention of the first keyword of interest, the adding the data that identifies the first excerpt including:
adding an identifier for the first audio recording; and
adding data to locate the first excerpt in the first audio recording;
accepting, from the user, a selection of a second audio recording for playback by the media player;
accepting, from the user, another selection of the user interface element in the media player; and
adding to the playlist, responsive to the another selection of the user interface element, data that identifies a second excerpt, from the second audio recording, that includes a mention of a second keyword of interest, the adding the data that identifies the second excerpt including:
adding an identifier for the second audio recording.

14. The method of claim 13, wherein the first audio recording and the second audio recording are each of a conversation between an agent of a call center and a caller.

15. The method of claim 13, wherein the data to locate the first excerpt in the first audio recording includes an identifier for the first keyword of interest, and wherein the first keyword of interest and the second keyword of interest are the same.

16. The method of claim 13, wherein
the data to locate the first excerpt in the first audio recording includes an identifier for the first keyword of interest,
the adding the data that identifies the second excerpt further includes adding data to locate the second excerpt in the second audio recording,
the data to locate the second excerpt in the second audio recording includes an identifier for the second keyword of interest, and
the first keyword of interest is different from the second keyword of interest.

17. The method of claim 13, wherein the data to locate the first excerpt in the first audio recording includes an identifier for the first keyword of interest and an indication of a position of the mention of the first keyword of interest in the first audio recording, and wherein the indication of the position is an index, as measured from a beginning of the first audio recording, of the mention of the first keyword of interest in mentions of the first keyword of interest in the first audio recording.

18. The method of claim 13, wherein the data to locate the first excerpt in the first audio recording includes an indication of a position of the mention of the first keyword of interest in the first audio recording, and wherein the indication of the position is an offset relative to a beginning of the first audio recording.

19. The method of claim 13, wherein the creating further includes:
accepting, from the user, a selection of a caret in the media player from carets that indicate mentions of the first keyword of interest in the first audio recording, wherein the selected caret indicates the mention included in the first excerpt.

20. The method of claim 13, the method further comprising:
creating a transcript for the playlist, the creating the transcript including:
adding, to the transcript for the playlist, a first portion of a transcript for the first audio recording that corresponds to the first excerpt of the first audio recording, and
adding, to the transcript for the playlist, a second portion of a transcript for the second audio recording that corresponds to the second excerpt of the second audio recording.
